(19) United States
(12) Patent Application Publication
(10) Pub. No.: US 2011/0317950 A1
(43) Pub. Date: Dec. 29, 2011

(54) Motor device

(75) Inventor: Jong Ho Lee, Suwon (KR)

(73) Assignee: Samsung Electro-Mechanics Co., Ltd., Suwon (KR)

(21) Appl. No.: 13/067,815

(22) Filed: Jun. 28, 2011

(30) Foreign Application Priority Data
Jun. 29, 2010 (KR) 10-2010-0062291

(51) Int. Cl. F16C 32/06

(52) U.S. Cl. 384/112

(57) ABSTRACT

Disclosed is a motor device. The motor device according to an exemplary embodiment of the present invention includes a sleeve having a shaft hole expanding downwardly in an axial direction; a shaft having a head part having exposed to a top portion of the sleeve and a body part having a shape corresponding to the shaft hole; a rotor case combined to the head part and rotating in connection with the shaft; an oil sealing part formed between the rotor case and the sleeve and an oil interface to seal oil provided to have a taper shape; and a thrust dynamic part formed on at least one of the rotor case and the sleeve and pumping the oil interface in an inner-diameter direction from the oil interface at the time of the rotation of the rotor case.

### CROSS-REFERENCE TO RELATED APPLICATIONS

This application claims the priority of Korean Patent Application No. 10-2010-0062291 filed on Jun. 29, 2010, in the Korean Intellectual Property Office, the disclosure of which is incorporated herein by reference.

### BACKGROUND OF THE INVENTION

1. Field of the Invention

The present invention relates to a motor device, and more particularly, to a motor device capable of resisting deformation due to an external force.

2. Description of the Related Art

A small-sized spindle motor used for a recording disk driver uses a hydrodynamic bearing assembly. In this case, oil is interposed between a shaft and a sleeve of the hydrodynamic bearing assembly. Meanwhile, the hydrodynamic bearing assembly is referred to as a mechanism that supports the shaft by fluid pressure generated from the oil.

In particular, as a spindle motor for a hard disk drive (HDD) is widely used in various types of portable products such as netbooks, mobile phones, PMPs, game machines, and the like, research into the miniaturization of the spindle motor has been actively conducted.

Generally, the hydrodynamic bearing assembly of the spindle motor is configured to include a shaft, a sleeve, a thrust plate generating axial dynamic pressure, a cap member preventing a leakage of oil, and a base plate.

Therefore, the hydrodynamic bearing assembly according to the related art is configured of a large number of parts, such that part management or an assembly process at the time of developing the hydrodynamic bearing assembly may be complicated.

In addition, when an external impact is applied to the spindle motor including the hydrodynamic bearing assembly, the cap member or the thrust plate may be broken.

Therefore, a need exists for a method capable of preventing a breakage due to an external impact by reducing the number of parts included in a hydrodynamic bearing assembly as compared with those of the related art, without affecting the generation of dynamic pressure for rotating a motor.

### SUMMARY OF THE INVENTION

An aspect of the present invention is to provide a motor device in which a structure of a shaft and a sleeve is deformed so as to prevent a breakage of the motor due to an external impact and simplify an assembly process.

According to an exemplary embodiment of the present invention, there is provided a motor device, including: a sleeve having a shaft hole expanding downwardly in an axial direction; a shaft having a head part exposed to a top portion of the sleeve and a body part having a shape corresponding to the shaft hole; a rotor case combined to the head part and rotating in connection with the shaft; an oil sealing part formed between the rotor case and the sleeve and having an oil interface to seal oil to have a taper shape; and a thrust dynamic part formed on at least one of the rotor case and the sleeve and pumping the oil interface in an inner-diameter direction from the oil interface at the time of the rotation of the rotor case.

The oil sealing part may be formed between the top surface of the sleeve and the bottom surface of the rotor case formed to be sloped upwardly in an outer diameter direction.

The oil sealing part may be formed between the bottom surface of the rotor case and the top surface of the sleeve formed to be sloped downwardly in an outer diameter direction.

The oil sealing part may be formed between the bottom surface of the rotor case formed to be sloped upwardly in an outer diameter direction and the top surface of the sleeve formed to be sloped downwardly in an outer diameter direction.

The rotor case may include a wall part housing the sleeve and protruded downwardly in an axial direction, and the oil sealing part is formed between an outer circumferential surface of the sleeve and an inner surface of the wall part.

The oil may be filled between the outer circumferential surface of the body part and the inner circumferential surface of the sleeve and at least one of the outer circumferential surface of the body part or the inner circumferential surface of the sleeve may be provided with at least one radial dynamic groove to generate dynamic pressure at the time of the rotation of the rotor case.

The radial dynamic grooves may be formed on at least one of the outer circumferential surface of the body part or the inner circumferential surface of the sleeve, both upwardly and downwardly in an axial direction.

The radial dynamic groove may be formed to have a herringbone structure to generate a floating force by moving the oil downwardly in the axial direction.

The radial dynamic grooves may be concavely formed to have different lengths based on a center of the radial dynamic groove.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor device according to an exemplary embodiment of the present invention;

FIG. 2 is a schematic diagram depicting a shaft provided in the motor device according to the exemplary embodiment of the present invention as cut and flattened outspread;

FIG. 3 is a schematic cross-sectional view showing a motor device according to another exemplary embodiment of the present invention;

FIG. 4 is a schematic cross-sectional view showing a motor device according to another exemplary embodiment of the present invention; and

FIG. 5 is a schematic cross-sectional view showing a motor device according to another exemplary embodiment of the present invention.

### DETAILED DESCRIPTION OF THE PREFERRED EMBODIMENT

Hereinafter, exemplary embodiments will be described in detail with reference to the accompanying drawings so that they can be easily practiced by those skilled in the art to which the present invention pertains. However, in describing the exemplary embodiments of the present invention, detailed descriptions of well-known functions or constructions are omitted so as not to obscure the description of the present invention with unnecessary detail.

In addition, like reference numerals denote parts performing similar functions and actions throughout the drawings.

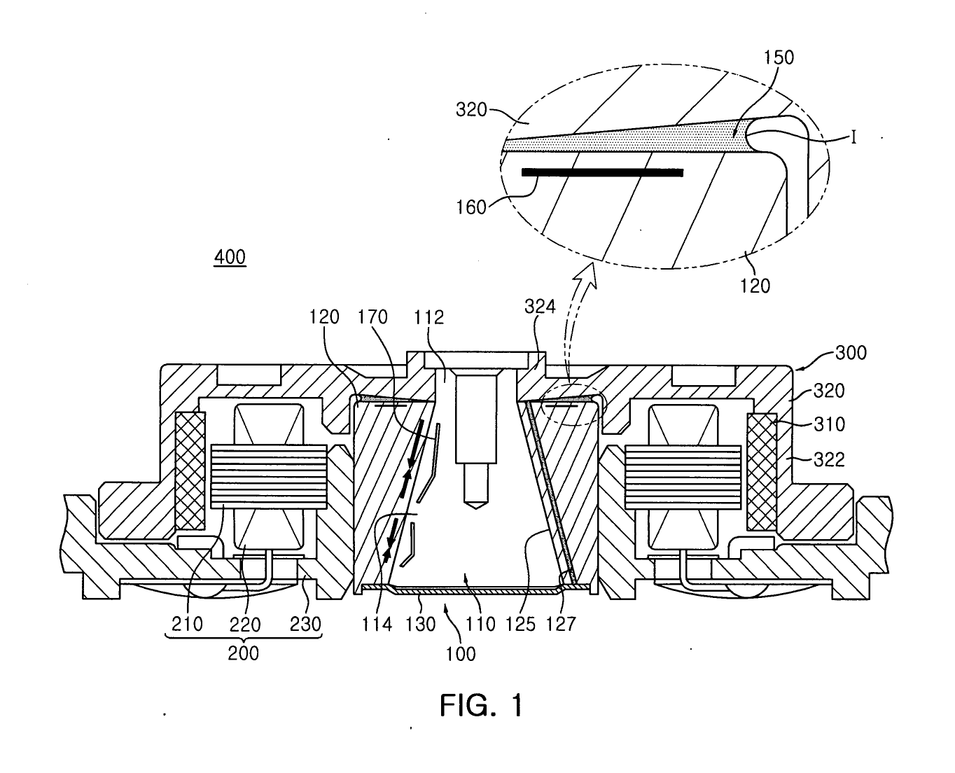

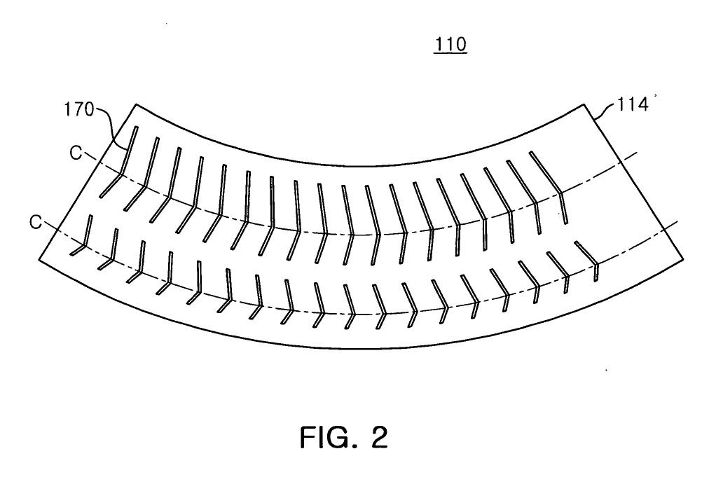

FIG. 1 is a schematic cross-sectional view showing a motor device according to an exemplary embodiment of the present invention and FIG. 2 is a schematic diagram of a shaft provided in the motor device according to the exemplary embodiment of the present invention as cut and flattened outspread.

Referring to FIGS. 1 and 2, a motor device 400 according to an exemplary embodiment of the present invention may include a hydrodynamic bearing assembly 100, a stator 200, and a rotor 300.

Detailed exemplary embodiments of the hydrodynamic bearing assembly 100 will be described in detail below and the motor 400 according to the exemplary embodiment of the present invention may have all of the detailed characteristics of each exemplary embodiment of the hydrodynamic bearing assembly 100.

The stator 200 may be a fixed structure that includes a winding coil 220 generating a predetermined amount of electromagnetic force at the time of the application of power and a plurality of cores 210 on which the winding coil 220 is wound.

The core 210 may fixedly be disposed on the top of a base 230 on which a printed circuit board (not shown) having a circuit pattern printed thereon is provided, and the top surface of the base 230, corresponding to the winding coil 220, may be provided with a plurality of coil holes having a predetermined size penetrating through the top surface thereof in order to expose the winding coil 220 downwardly, and the winding coil 220 may be electrically connected with the printed circuit board (not shown) in order to supply external power.

The rotor 300 may be a rotating structure that is rotatably provided with respect to the stator 200 and may include a rotor case 320 having an annular ring magnet 310 at a predetermined interval from the core 210 while being provided at an inner circumferential surface of the rotor case 320.

The magnet 310 may be a permanent magnet of which an N pole and an S pole are alternately magnetized in a circumferential direction to generate a predetermined amount of magnetic force.

In this configuration, the rotor case 320 may be configured to include a base part 324 that is combined and fixed to the top end of a shaft 110, that is, a head part 112 of the shaft 110 to be described below and a magnet support part 322 that extends in an outer-diameter direction from the base part 324 and is bent downwardly in an axial direction so as to support the magnet 310 of the rotor 300.

In addition, the hydrodynamic bearing assembly 100 according to the exemplary embodiment of the present invention may include the shaft 110, a sleeve 120, an oil sealing part 150, a thrust dynamic part 160, and radial dynamic grooves 170.

First, when defining terms regarding directions, an axial direction refers to a vertical direction based on the shaft 110 while an outer-diameter direction and an inner-diameter direction refer to an outer edge direction of the rotor 300 based on the shaft 110 or a central direction of the shaft 110 based on the outer edge of the rotor 300.

The sleeve 120 may support the shaft 110 so that the top end of the shaft 110 is protruded upward axially.

In other words, the sleeve 120 may have a shaft hole 125 expanding downwardly in an axial direction and have an inner circumferential surface corresponding to an outer circumferential surface of the shaft 110.

In other words, the shaft 110 may include the head part 112 having a predetermined diameter exposed to the top of the sleeve 120 and a body part 114 having a conical outer circumferential surface having a shape corresponding to the shaft hole 125.

In this case, the shaft 110 may be inserted into the conical shaft hole 125 of the sleeve 120 such that a micro gap exists therebetween, wherein the micro gap may be filled with oil.

Further, the outer circumferential surface of the shaft 110, that is, the surface of the body part 114 thereof, may be provided with at least one concavely formed radial dynamic groove 170.

An example of the radial dynamic groove 170 may include a herringbone-shaped groove, wherein the herringbone-shaped groove generates radial dynamic pressure to smoothly support the rotation of the shaft 110.

However, the radial dynamic grooves 17.0 are not necessarily formed in the body part of the shaft 110 as shown in FIG. 1. Therefore, even in the case that the radial dynamic grooves 170 are formed in the inner circumferential surface of the sleeve 120, the same amount of radial dynamic pressure may be generated.

In this case, the oil may be supplied to the gap between the body part 114 of the shaft 110 and the sleeve 120 to be filled in the radial dynamic grooves 170, and, when the motor 400 is driven, the fluid filled in the radial dynamic grooves 170 that are formed in the sleeve 120 has strong pressure applied thereto to form a fluid film.

Therefore, a sliding surface between the sleeve 120 and the rotor 300 may be in a fluid friction state in order to minimize a friction load, such that the motor may be rotated without noise and vibrations.

Referring to FIG. 2, the radial dynamic grooves 170 that are concavely formed on the outer circumferential surface of the shaft 110 may be formed to have the herringbone shape as described above, but may be formed to have a spiral shape according to the design of the motor. However, the shape of the radial dynamic groove 170 may not be limited to the above shape, but may be variously set differently from the above description according to the designer's intention.

In addition, the radial dynamic grooves 170 may be simply manufactured through cutting, coining, etching and laser machining methods, as well as an electrolytic machining method.

Therefore, since only the outer circumferential surface of the shaft 110 or the inner circumferential surface of the sleeve 120 may be provided with the radial dynamic grooves 170 having various shapes, which are precisely machined to have a micro size, in order to stably drive the motor, the machining cost of the motor may be reduced, thereby reducing the manufacturing cost of the motor.

The radial dynamic grooves 170 may be formed on at least one of the outer circumferential surface of the body part 114 and the inner circumferential surface of the sleeve 120, both upwardly and downwardly in an axial direction, and may be concavely formed to have different lengths based on the center C of the radial dynamic groove 170.

Therefore, the dynamic pressure at the time of the rotation of the motor may be formed in the directions of the arrows shown in FIG. 1 by allowing the lengths of the radial dynamic grooves 170 different, and dynamic pressure may be formed upwardly in an axial direction, while the oil is filled between the bottom surface of the shaft 110 and a base cover 130, thereby generating a floating force in the shaft 110.

In this case, the oil may move to a bypass channel 127 formed to penetrate through the sleeve 120 without stagnating between the sleeve 120 and the shaft 110 and thus, the fluid is circulated without stagnating, which may extend the lifespan of both the fluid and the motor 400 at the time of the driving of the motor 400.

The radial dynamic grooves 170 are not necessarily provided on the outer circumferential surface of the shaft 110 as described above and therefore, may be similarly provided on the inner circumferential surface of the sleeve 120.

In addition, the bypass channel 127 may be not necessarily formed in parallel with the outer circumferential surface of the body part 114 as shown in FIG. 1, and may be formed in parallel with the axial direction if the fluid can be circulated without stagnating the fluid.

In addition, an oil sealing part 150 forming an oil interface I of sealed oil provided to have a taper shape may be formed between the top surface of the sleeve 120 and the bottom surface of the rotor case 320.

The oil sealing part 150 that uses a capillary phenomenon in order to prevent the oil from leaking to the outside at the time of the driving of the motor may be formed between the top surface of the sleeve 120 and the bottom surface of the rotor case 320 formed to be sloped upwardly in an outer diameter direction.

That is, the oil sealing part 150 may be provided so that the bottom surface of the rotor case 320, corresponding to the top surface of the sleeve 120, is formed to be sloped upwardly in an outer diameter direction.

In this case, the top surface of the sleeve 120 may be provided with a thrust dynamic part 160 that pumps the oil interface I in the inner-diameter direction at the time of the driving of the motor.

In other words, the thrust dynamic part 160 may provide the thrust dynamic pressure to the shaft 110 and may be formed on the bottom surface of the rotor case 320.

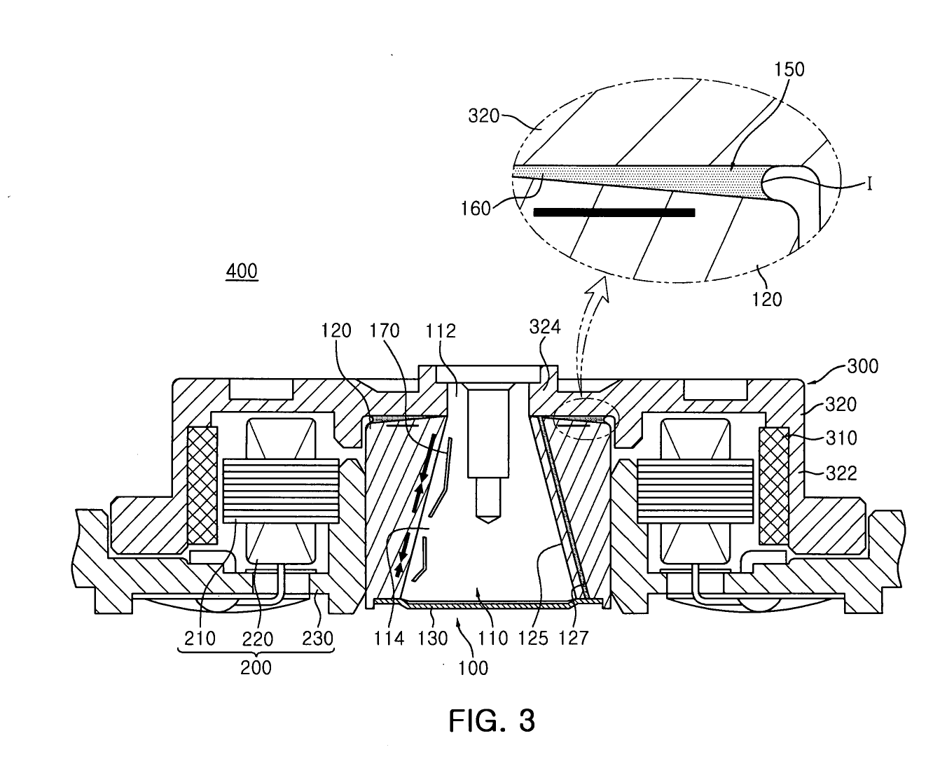

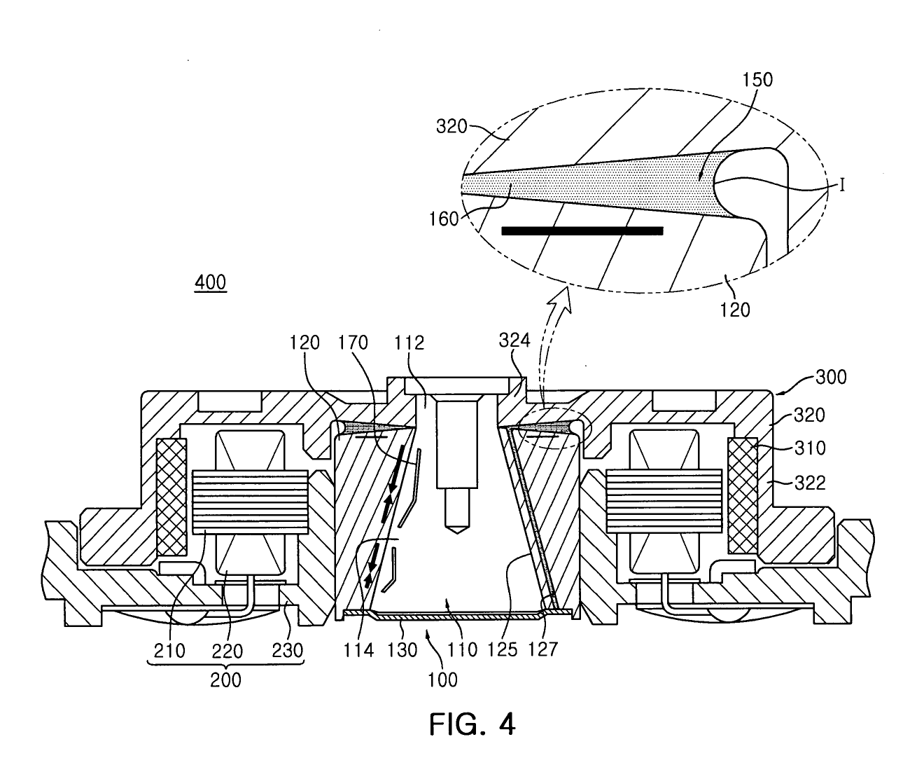

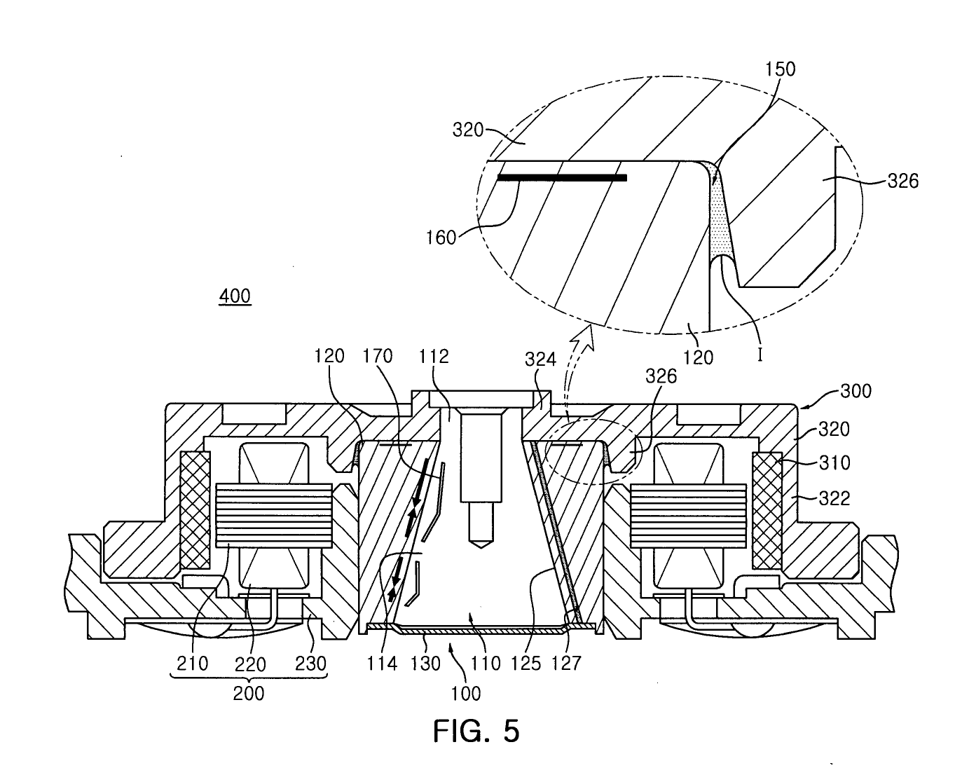

FIG. 3 is a schematic cross-sectional view showing a motor device according to another exemplary embodiment of the present invention and FIGS. 4 and 5 are schematic cross-sectional views showing a motor device according to another exemplary embodiment of the present invention.

Referring to FIGS. 3 through 5, the motor device 400 according to another exemplary embodiment of the present invention may be the same as the configuration and effect of the above-mentioned exemplary embodiment, other than the oil sealing part 150, and therefore, a detailed description thereof will be omitted.

The oil sealing part 150 that uses the capillary phenomenon in order to prevent the oil from leaking to the outside at the time of the driving of the motor may be formed between the bottom surface of the rotor case 320 and the top surface of the sleeve 120 formed to be sloped downwardly in an outer diameter direction.

That is, the oil sealing part 150 may be provided so that the top surface of the sleeve 120, corresponding to the bottom surface of the rotor case 320, is formed to be sloped downwardly in an outer diameter direction.

In addition, the oil sealing part 150 may be formed between the bottom surface of the rotor case 320 formed to be sloped upwardly in an outer diameter direction and the top surface of the sleeve 120 formed to be sloped downwardly in an outer diameter direction.

In addition, the rotor case 320 may include a wall part 326 protruded downwardly in an axial direction housing the sleeve 120, and the oil sealing part 150 may be formed between the outer circumferential surface of the sleeve 120 and the inner surface of the wall part 326.

That is, the oil sealing part 150 may be provided such that the inner circumferential surface of the wall part 326 corresponding to the outer circumferential surface of the sleeve 120 is formed to have a increased diameter downwardly in an axial direction.

Through the above-mentioned exemplary embodiment, the radial dynamic grooves 170 are concavely formed to have different lengths, thereby providing the floating force to the shaft 110 at the time of the driving of the motor.

In addition, the oil sealing part 150 forming the oil interface may be provided between the sleeve 120 and the rotor case 320 and the thrust dynamic part 160 may be provided on at least one of the top surface of the sleeve 120 or the bottom surface of the rotor case 320, such that a separate member providing thrust dynamic pressure is not required, thereby reducing the number of parts of the hydrodynamic bearing assembly 100 provided to the motor device 400

Therefore, the exemplary embodiment of the present invention may simplify the assembly process and prevent breakage of the hydrodynamic bearing assembly 100 due to an external impact.

As set forth above, the motor device according to the exemplary embodiment of the present invention may prevent the deformation occurring at the time of assembling by reducing the number of parts and the breakage due to the external impact.

In addition, the exemplary embodiment of the present invention may change the structure of the oil sealing part and the thrust dynamic groove in order to generate the dynamic pressure enough to rotate the motor.

While the present invention has been shown and described in connection with the exemplary embodiments, it will be apparent to those skilled in the art that modifications and variations can be made without departing from the spirit and scope of the invention as defined by the appended claims.

What is claimed is:

1. A motor device, comprising:
a sleeve having a shaft hole expanding downwardly in an axial direction;
a shaft having a head part exposed to a top portion of the sleeve and a body part having a shape corresponding to the shaft hole;
a rotor case combined to the head part and rotating in connection with the shaft;
an oil sealing part formed between the rotor case and the sleeve and having an oil interface to seal oil provided to have a taper shape; and
a thrust dynamic part formed on at least one of the rotor case and the sleeve and pumping the oil interface in an inner-diameter direction from the oil interface at the time of the rotation of the rotor case.

2. The motor device of claim 1, wherein the oil sealing part is formed between the top surface of the sleeve and the bottom surface of the rotor case formed to be sloped upwardly in an outer diameter direction.

3. The motor device of claim 1, wherein the oil sealing part is formed between the bottom surface of the rotor case and the top surface of the sleeve formed to be sloped downwardly in an outer diameter direction.

4. The motor device of claim 1, wherein the oil sealing part is formed between the bottom surface of the rotor case formed to be sloped upwardly in an outer diameter direction and the top surface of the sleeve formed to be sloped downwardly in an outer diameter direction.

5. The motor device of claim 1, wherein the rotor case includes a wall part housing the sleeve and protruded downward in the axial direction, and
the oil sealing part is formed between an outer circumferential surface of the sleeve and an inner surface of the wall part.

6. The motor device of claim 1, wherein the oil is filled between the outer circumferential surface of the body part and the inner circumferential surface of the sleeve, and at least one of the outer circumferential surface of the body part or the inner circumferential surface of the sleeve is provided with at least one radial dynamic groove to generate dynamic pressure at the time of the rotation of the rotor case.

7. The motor device of claim 6, wherein the radial dynamic grooves are formed on at least one of the outer circumferential surface of the body part or the inner circumferential surface of the sleeve both upward and downward in the axial direction.

8. The motor device of claim 6, wherein the radial dynamic groove is formed to have a herringbone structure to generate a floating force by moving the oil downward axially.

9. The motor device of claim 6, wherein the radial dynamic grooves are concavely formed to have different lengths based on a center of the radial dynamic groove.
